(19) United States
(12) Patent Application Publication
(10) Pub. No.: US 2013/0341164 A1
(43) Pub. Date: Dec. 26, 2013

(54) LABEL CONVEYOR BELT

(71) Applicant: Multivac Marking & Inspection GmbH & Co. KG, Enger (DE)

(72) Inventors: Hendrik Frank, Enger (DE); Daniel Siegenbrink, Bielefeld (DE)

(21) Appl. No.: 13/926,468

(22) Filed: Jun. 25, 2013

(30) Foreign Application Priority Data
Jun. 26, 2012 (DE) 102012012725.1

(51) Int. Cl. B65G 15/54

(52) U.S. Cl. CPC B65G 15/54
USPC 198/846

(57) ABSTRACT

The invention relates to a label conveyor belt including a carrier material. It is characterized in that a carrier material of the label conveyor belt has applied thereto a nano- or micro structured coating.

### CROSS-REFERENCE TO RELATED APPLICATIONS

This Application claims priority to German Application Number 102012012725.1 filed Jun. 26, 2012, to Hendrik Frank and Daniel Siegenbrink entitled “Label Conveyor Belt,” currently pending, the entire disclosure of which is incorporated herein by reference.

### FIELD OF THE INVENTION

The invention relates to a label conveyor belt.

### BACKGROUND OF THE INVENTION

WO 03/099951 A2 discloses a microstructured surface with increased adherence comprising a plurality of elastic projections. According to the so-called van der Waals interaction, this surface adheres to other objects. DE 10 2010 044 660 A1 discloses an improved embodiment of projections, which enhances the adhesion and separation properties still further. However, none of these two documents is related to labeling technology in any way.

DE 10 228 243 A1, which is owned by the applicant himself, discloses a cross-web labeller with a suction box including at least one fan, which provides for a partial vacuum at the label conveyor belt so as to be able to hold labels with their non-adhesive upper surface on the lower surface of the label conveyor belt during transport. Fans are not always advantageous from the hygienic point of view.

### SUMMARY OF THE INVENTION

It is the object of the present invention to provide a label conveyor belt with improved adhesive properties.

The label conveyor belt according to the present invention includes a carrier material and is characterized in that the carrier material may have applied thereto a nano- or microstructured coating, which is configured to hold at least one label precisely in position on the coating during transport of said label. The phrase “precisely in position” means that, even when the label is conveyed by the label conveyor belt, the position of the label will not change due to forces of weight or inertia with respect to its position relative to the label conveyor belt. A nanostructured coating in the sense of the present invention is a coating having surface structures in a range of about 100 nm or less. A microstructured coating is a coating having surface structures in a range of about 0.1 μm to about 100 μm. The respective surface structures may be the diameters or radii of curvature of the heads or tips of adhesion elements.

The adhesive properties provided by the nano- or microstructured coating allow an adherence of labels with their adhesive as well as with their non-adhesive side. The adhesive properties also allow the labels to be conveyed on the lower surface of a label conveyor belt, without any necessity of holding the labels by means of a vacuum on the label conveyor belt.

According to one embodiment, the microstructured coating of the label conveyor belt has a surface including more than 15,000 adhesion elements per cm², preferably more than 25,000 adhesion elements per cm². This embodiment is particularly suitable for making smooth surfaces adhere to the coating, such smooth surfaces existing, for example, in the case of imprinted labels on the top face or visible face of the labels. At the same time, the coating allows the labels to be easily removed or detached by means of peeling off, since the good adhesive properties are effective primarily transversely and perpendicularly to the level of the coating.

According to one embodiment, the coating is a silicone coating and is therefore easy to clean as well as flexible.

The carrier material may be a fabric, preferably a textile fabric, so that it will be particularly suitable for conveying labels.

The carrier material can be a multilayer material so that the label conveyor belt can also be run around very small diameters and/or an appropriate surface for applying thereto the coating can be provided.

The coating can be configured to hold the label with its non-adhesive side during transport of the label. It is no longer necessary to provide a vacuum by means of fans, and the structural design can thus be simplified. A change of the adhesive properties, which would be negatively influenced by the adhesive of the adhesive side of the labels if the labels were conveyed with their adhesive lower surface, is prevented.

The label conveyor belt may be endless so that it can be used, for example, in a cross-web labeller.

The coating is preferably configured to hold the label on the basis of van der Waals forces so as to guarantee good adhesion and easy separation of the labels.

Other and further objects of the invention, together with the features of novelty appurtenant thereto, will appear in the course of the following description.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a side schematic view of a label conveyor belt according to one embodiment of the present invention; and

FIG. 2 is an enlarged schematic representation of a cross-section of the label conveyor belt according to one embodiment of the present invention.

Identical components are provided with identical reference numerals throughout the figures.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

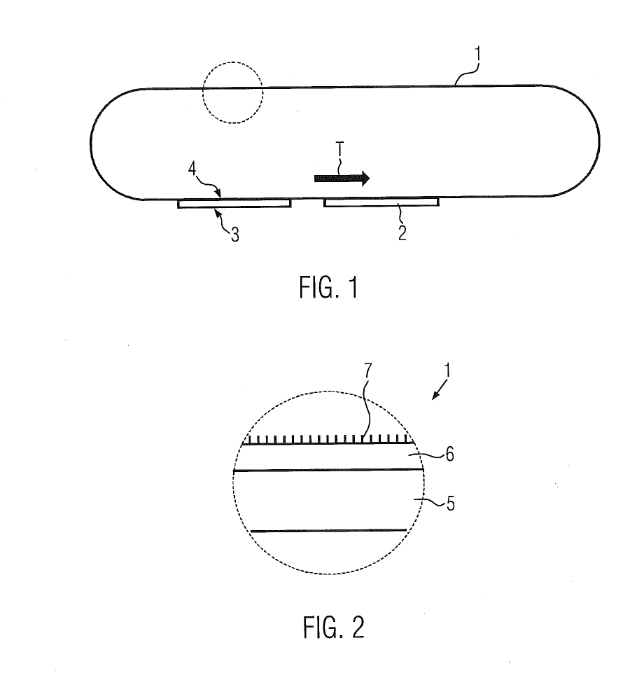

FIG. 1 shows an endless label conveyor belt 1 according to one embodiment of the present invention conveying labels 2 in a direction of transport T. The adhesive side 3 of the label 2 is here the lower surface of the label 2 and the non-adhesive side 4 is the upper surface of the label 2, which faces the label conveyor belt 1.

In the enlarged representation of a cross-section of the label conveyor belt 1, which is schematically shown in FIG. 2, a carrier layer 5 and a nano- or microstructured silicone coating 6, which is joined to the carrier layer 5, are schematically shown. The coating is, for example, permanently preformed and then applied by means of an adhesive or applied directly to the carrier material by means of casting, forming or coating. Adhesion elements 7 are provided so that labels can be held with their non-adhesive sides on the basis of van der Waals forces, at least about 15,000 of said adhesion elements 7 being provided per cm² in the label conveyor belt area provided for conveying the labels 2.

The carrier layer 5 may be a fabric, for example, a textile fabric, or it may be configured as a multilayer material so as to guarantee the properties of a circulating belt and provide, in addition, an improved surface for applying the coating 6.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A label conveyor belt comprising a carrier material, wherein the carrier material has applied thereto a nano- or microstructured coating, which is configured to hold at least one label precisely in position on the coating during transport of said label.

2. The label conveyor belt according to claim 1, wherein the coating is a microstructured coating having a surface comprising more than 15,000 adhesion elements per cm².

3. The label conveyor belt according to claim 1, wherein the coating is a microstructured coating having a surface comprising more than 25,000 adhesion elements per cm².

4. The label conveyor belt according to claim 1, wherein the coating is a silicone coating.

5. The label conveyor belt according to claim 1, wherein the carrier material is a fabric.

6. The label conveyor belt according to claim 1, wherein the carrier material is a textile fabric.

7. The label conveyor belt according to claim 1, wherein the carrier material is a multilayer material.

8. The label conveyor belt according to claim 1, wherein the coating is configured to hold the label with its non-adhesive side during transport of said label.

9. The label conveyor belt according to claim 1, wherein the label conveyor belt is endless.

10. The label conveyor belt according to claim 1, wherein the coating is configured to hold the label on the basis of van der Waals forces.
